(19) United States
(12) Patent Application Publication
(10) Pub. No.: US 2005/0177473 A1
(43) Pub. Date: Aug. 11, 2005

(54) Process for incorporation of exchange traded portfolios (a.k.a. exchange traded funds) into life insurance or annuity policies with an optional principal protection feature

(76) Inventor: Christopher Todd Angle, Redding, CT (US)

Correspondence Address: CHRISTOPHER ANGLE, 19 TOPLEDGE ROAD, REDDING, CT, 06896, US

(21) Appl. No.: 10/764,925

(22) Filed: Jan. 26, 2004

(51) Int. Cl. G06F 17/60

(52) U.S. Cl. 705/30

(57) ABSTRACT

A process for Incorporation of Exchange Traded Portfolios (a.k.a. Exchange Traded Funds) Into Life Insurance or Annuities with an Optional Principal Protection Feature with the steps of: Establishing variable life insurance and /or annuity products; Make available the various ETF's instead of or in addition to mutual funds; and the application of a put option protection feature. This method and utility is for owners of rife insurance and annuity products and will make these products more efficient in providing benefits and features of ETF's. This method is accomplished by utilizing the efficiencies of the ETF's traded for the most part on the American Stock Exchange instead of, or in addition to, the use of mutual funds. Also, the ETF's have derivative products (options) which can be used to construct a hedge to protect the principal value of the policy which may consist of mutual funds or ETF's or both.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of insurance products of Life and Annuity Policies and more specifically to a process for incorporation of Exchange Traded Portfolios (a.k.a. Exchange Traded Funds) into Life Insurance or Annuities with an Optional Principal Protection Feature.

This invention generally relates to the field of investment in Exchange Traded Portfolios/Funds which would be used inside of life insurance or annuity policies instead of, or in addition to, the traditional mutual funds. In the mid-90's the American Stock Exchange in order to compete with the New York Stock Exchange invented the Exchange Traded Fund (ETF). These are index funds that are traded like stocks as opposed to mutual funds.

The Exchange Traded Funds are similar to Index Mutual Funds in that they consist of all the stocks that make up the index, such as an S & P 500 index, and they include a management fee; however, they are sold not as mutual funds, but as single stocks mostly on the American Stock Exchange. (Due to their success, some ETF's have begun to trade on other exchanges, such as the New York Stock Exchange.)

Since their invention in the mid-90's ETF's have become very successful as their volume on the exchanges have increased dramatically. In addition to the advent of the ETF's trading as stocks, various derivative products have in accordance appeared to augment their versatility. Examples of these derivatives are: options of the ETF's. Futures Contracts of the ETF's, and options on the Futures.

These options on the ETF stocks along with the options on the Futures Contracts if purchased in conjunction with the ETF themselves can provide a hedge that can protect the value of the ETF.

As insurance companies use mutual funds to provide life insurance (known as variable life insurance) and annuities (also known as variable annuities) with the investment vehicle by which the value of the policies can grow (or depreciate as there is risk involved), the ETF's could be used as a substitute for the mutual funds creating additional benefits and efficiencies yet still maintaining the same diversity required by the insurance industry and its regulations.

### BRIEF SUMMARY OF THE INVENTION

The primary object of the invention is to make the insurance product, overall, through the use of ETF's, more efficient than mutual funds.

Another object of the invention is to increase liquidity.

Another object of the invention is to provide a market throughout the day on a major exchange in the same way as stocks are traded.

A further object of the invention is to allow the investment vehicle the potential to be shorted; that is, to allow the investment the potential to appreciate even in a down market.

Yet, another object of the invention is to lower expense ratios.

Still yet, another object of the invention is to eliminate short-term redemption fees.

Another object of the invention is to make put options available that would enable the insurer to offer a put protection feature that hedges the principal.

Another object of the invention is to allow for immediate diversification.

Other objects and advantages of the present invention will become apparent from the following descriptions, taken in connection with the accompanying drawing, wherein, by way of illustration and example, and embodiment of the present invention is disclosed.

In accordance with a preferred embodiment of the invention, there is disclosed a process for incorporation of Exchange Traded Portfolios (a.k.a. Exchange Traded Funds) into Life Insurance or Annuities with an Optional Principal Protection Feature comprising the steps of: establishing variable life insurance and/or annuity products, make available the various ETF's instead of or in addition to mutual funds, and the application of a put option feature.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 sis a flow chart of the operations that comprise the method.

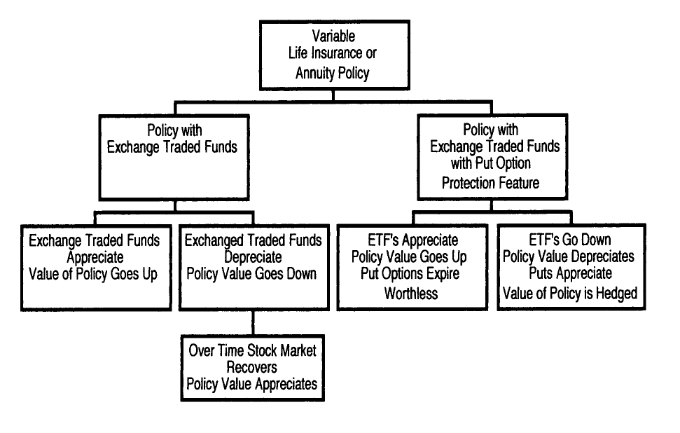

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The primary object of the invention is that it allows an alternative to mutual funds (which may be very desirable to some investors) for the insurance industry to use for their life insurance and annuity products.

Further, its object is to provide additional derivative products of the ETF's for use as a hedge on the principal value of the policy which is provided by the investors' payments into the policies.

Another objective is to increase the efficiencies of the policies due to the unique attributes of the ETF's which include low expense ratios.

The steps are:

1) Establishing variable life insurance and/or annuity products;

2) Make available the various ETF's instead of or in addition to mutual funds;

3) For principal protection of the insured's payments that go to the principal and contribute to the cash value of the policy, the invention provides the application of a put option protection position.

A life insurance or annuity policy is a product that is comprised of an underlining investment vehicle to provide the owner of the policy with its desired features, well known to those investor/owners of life insurance and annuities, with anticipated capital appreciation over time. Typically, there are fixed life insurance and annuity policies that invest in bonds or real estate and have a stable income feature which enables the policy to appreciate at more or less a stable rate.

As an alternative, insurance companies also employ variable policies to give buyers of life and annuity policies the chance of a greater return in the long-term arena of investing. These policies use mutual funds as their preferred method of investment to hopefully see capital appreciation of the value of the policy over time. Many of these types of policies offer indexed mutual funds from which policy owners may choose such as the S & P 500, the Dow Jones Industrial Average, the NASDAQ 100, The Russell 2000, and others.

Instead of mutual funds, Exchange Traded Funds can be incorporated into the life insurance or annuity policy and still satisfy the industry's and insurance regulator's need for sufficient diversification. ETF's trade as a stock on a major exchange, and hence, unlike mutual funds, they trade throughout the day. Therefore, a policy owner recognizing a favorable time to increase his position inside the policy or deciding to re-allocate positions already established does not have to wait for the end of the day as he must for mutual funds. He may execute his decision immediately. Due to the liquidity of the ETF's, the policy owner can obtain an immediate and efficient execution to establish his new position.

A major and highly important point is that ETF's can be shorted so that a policy owner has the potential to establish an appreciating position even in a bear market which is impossible to do using mutual funds. This allows the policyholder the potential to avoid a disastrous, prolonged bear market as previously experienced from years 2000 to 2003.

Further, ETF's tend to have lower expense ratios associated with their ownership than mutual funds. Also, there are no short-term redemption fees which can be experienced using mutual funds.

Life and particularly annuity policies sometimes have principal guarantee features associated with them. With the larger indexed ETF's such as those mentioned above there are options available that would enable the insurer to offer an option put protection feature that hedges the principal amount invested by the policy owner. If the stock market turns bearish, the put protection feature would hedge the depreciation of the ETF's.

Of course, if the stock market is bullish and there is capital appreciation of the ETF's in the policy, then the puts will expire worthless and the cost of the put options (the premium) will detract from the performance of the capital appreciation of the ETF's. Hence, there is a cost for the put protection hedge placed on the policy protecting the principal.

This process will enable the owners of life insurance and annuity policies to more efficiently receive the benefits afforded to them by the policies, and yet, a) have the option of a principal hedge protection without an extended minimum retention period (typically seven years) and b) remain sufficiently diversified to the same extent as using mutual funds.

While the invention has been described in connection with a preferred embodiment, it is not intended to limit the scope of the invention to the particular form set forth, but on the contrary, it is intended to cover such alternatives, modification, and equivalents as may be included within the spirit and scope of the invention as defined by the appended claims.

1. A process for incorporation of Exchange Traded Portfolios (a.k.a. Exchange Traded Funds) into Life Insurance or Annuities with an Optional Principal Protection Feature comprising the steps of:
Establishing variable life insurance and/or annuity products;
Make available the various ETF's instead of or in addition to mutual funds; and
The application of a put option protection feature.
